(19) United States
(12) Patent Application Publication
(10) Pub. No.: US 2024/0021355 A1
(43) Pub. Date: Jan. 18, 2024

(54) POWER INDUCTOR DEVICE FOR AND MANUFACTURING METHOD THEREOF

(71) Applicant: TRIO Technology Co., Ltd. Seychelles Taiwan Branch, New Taipei City (TW)

(72) Inventors: Huo-Li LIN, New Taipei City (TW); Jin-Huo RAO, Hubei Province (CN); Ta-Wei WEI, Taichung City (TW)

(21) Appl. No.: 18/350,966

(22) Filed: Jul. 12, 2023

Related U.S. Application Data
(60) Provisional application No. 63/368,174, filed on Jul. 12, 2022.

(51) Int. Cl. H01F 27/255; H01F 41/02; H01F 27/32; H01F 1/24

(52) U.S. Cl. CPC H01F 27/255; H01F 41/0246; H01F 27/324; H01F 1/24

(57) ABSTRACT

A power inductor device and a manufacturing method thereof are provided. The power inductor device includes a first magnetic core body, a second magnetic core body and a metal conductor. The first magnetic core body is formed by a first magnetic powder and the second magnetic core body is formed by a second magnetic powder. The metal conductor is disposed in the accommodating space between the first magnetic core body and the second magnetic core body. The first magnetic core body, the metal conductor and the second magnetic body are closely combined by a heating and pressing molding process to obtain an integrated power inductor structure. The first magnetic powder and the second magnetic powder include an iron-based magnetic powder having the large particle size, the medium particle size and the small particle size.

### CROSS-REFERENCE TO RELATED APPLICATION

This application claims the benefit of U.S. Provisional Application No. 63/368,174, filed Jul. 12, 2022, the disclosure of which is incorporated by reference herein in its entirety.

### BACKGROUND OF THE INVENTION

### 1. Field of the Invention

The present invention generally relates to a power inductor device and a manufacturing method thereof, and in particular, to the integrated power inductor having high intensity inductor with better inductance value and saturation current capability, and the manufacturing cost is low.

### 2. Description of the Related Art

Due to the continuous development of the electronic products, the functional requirements are getting higher and higher, and the requirements for superimposed current are also increasing. While pursuing high efficiency, the loss of the inductive powder materials is also getting smaller and smaller. The conventional inductor and the manufacturing method are not able to meet the functional requirements of the current electronic products.

The conventional inductor can be made by single magnetic powder or composite magnetic powder. The different kinds of the magnetic powder may affect the frequency of use, the loss of the material, the product performance and the magnetic saturation capability. The single magnetic material is not able to meet the requirements of the inductor product. The composite magnetic material may increase the inductance value. However, the production cost and the material loss are not easy to control, and the material density is also difficult to meet the requirements. Although some product uses pre-pressing process to increase the density, the final product still can not meet the specific specs.

In summary, the conventional power inductor device and the manufacturing method thereof still has considerable problems. Hence, the present disclosure provides the power inductor device and the manufacturing method thereof to resolve the shortcomings of conventional technology and promote industrial practicability.

### SUMMARY OF THE INVENTION

In view of the aforementioned technical problems, the primary objective of the present disclosure is to provide the power inductor device and the manufacturing method thereof, which are capable of improving the density of the inductor with better inductance value and saturation current capability, and also reducing production cost.

In accordance with one objective of the present disclosure, a power inductor device is provided. The power inductor device includes a first magnetic core body, a second magnetic core body and a metal conductor. The first magnetic core body is formed by a first magnetic powder. The second magnetic core body is formed by a second magnetic powder, the second magnetic core body dispose on the first magnetic core body to form an accommodating space between the first magnetic core body and the second magnetic core body. The metal conductor is disposed in the accommodating space, and two ends of the metal conductor are exposed outside the first magnetic core body. The first magnetic core body, the metal conductor and the second magnetic body are closely combined by a heating and pressing molding process to obtain an integrated power inductor structure. Wherein the first magnetic powder and the second magnetic powder include an iron-based magnetic powder mixed with an adhesive, the iron-based magnetic powder has a first particle size, a second particle size and a third particle size, the first particle size is smaller than the second particle size and the second particle size is smaller than the third particle size.

Preferably, the first particle size may be 10 nm-5 μm, the second particle size may be 8.5 μm-15 μm, and the third particle size may be 18 μm-35 μm.

Preferably, the iron-based magnetic powder may have 80%-98.5% of unit weight and the adhesive may have 1.5%-20% of unit weight.

Preferably, the iron-based magnetic powder may include carbonyl (CIP), iron silicon chromium (Fe—Si—Cr), iron silicon aluminum (Fe—Si—Al), iron silicon (Fe—Si), amorphous, nanocrystalline alloy, iron nickel (FeNi), MPP iron nickel molybdenum (FeNiMo—C), silicon (Si), iron cobalt nickel (Fe—Co—Ni), manganese zinc (MnZn), nickel zinc (NiZn) or a combination thereof.

Preferably, particle size of the carbonyl may be 3 μm-8 μm, particle size of the iron silicon chromium may be 3 μm-35 μm, particle size of the nanocrystalline alloy may be 19 μm-23 μm, particle size of the amorphous may be 13 μm-28 μm, particle size of the iron nickel may be 12 μm-16 μm, particle size of the MPP iron nickel molybdenum may be 11 μm-18 μm.

Preferably, the iron-based magnetic powder may include a first powder and a second powder, the first powder and the second powder have same or different materials. Wherein the first powder has 5-95 weight of the iron-based magnetic powder and the second powder has 5-40 weight of the iron-based magnetic powder.

Preferably, the iron-based magnetic powder may include a first powder, a second powder and a third powder, the first powder, the second powder and the third powder have same or different materials. Wherein the first powder has 5-40 weight of the iron-based magnetic powder, the second powder has 5-40 weight of the iron-based magnetic powder and the third powder has 20-90 weight of the iron-based magnetic powder.

Preferably, the metal conductor may be made by gold, silver, copper, nickel or aluminum.

Preferably, the metal conductor may include a round coil or a flat coil, the metal conductor may be U shape, circle shape, ellipse shape, spiral shape, rectangular shape or I shape.

Preferably, the first magnetic core body may include a base and a columnar protrusion disposed on the base, the second magnetic core body may include a rectangular structure having a groove facing the columnar protrusion and two channels are extended from the groove. Wherein the groove and the columnar protrusion form the accommodating space and the two channels and the base form openings at side surface of the first magnetic core body, the metal conductor is disposed in the accommodating space and the two ends of the metal conductor pass through the openings.

Preferably, the two channels may be extended from the groove in same direction or in opposite direction.

Preferably, the first magnetic core body may include a plate structure, the second magnetic core body may include a rectangular structure having a groove and a columnar protrusion disposed in the groove, the columnar protrusion faces the plate structure and two channels extended from the groove. Wherein the groove and the columnar protrusion form the accommodating space and the two channels form openings at side surface of the second magnetic core body, the metal conductor is disposed in the accommodating space and the two ends of the metal conductor pass through the openings.

Preferably, the two channels may be extended from the groove in same direction or in opposite direction.

Preferably, heating temperature of the heating and pressing molding process may be 180° C.-300° C., forming pressure of the heating and pressing molding process may be 5-13 T/cm³ and full pressure time of the forming pressure may be 50 s-120 s.

Preferably, the power inductor device may further include an insulation layer, the insulation layer covers outside surface of the first magnetic core body and the second magnetic core body, and the two ends of the metal conductor are exposed outside the insulation layer.

In accordance with one objective of the present disclosure, manufacturing method of a power inductor device is provided. The manufacturing method includes following steps of: providing a first magnetic core body, a second magnetic core body and a metal conductor, the first magnetic core body being formed by a first magnetic powder and the second magnetic core body being formed by a second magnetic powder; assembling the first magnetic core body, the second magnetic core body and the metal conductor, the metal conductor being placing in an accommodating space between the first magnetic core body and the second magnetic core body and two ends of the metal conductor being exposed outside the first magnetic core body; conducting a heating and pressing molding process to the first magnetic core body, the second magnetic core body and the metal conductor to form an integrated power inductor structure; wherein the first magnetic powder and the second magnetic powder include an iron-based magnetic powder mixed with an adhesive, the iron-based magnetic powder having a first particle size, a second particle size and a third particle size, the first particle size is smaller than the second particle size and the second particle size is smaller than the third particle size.

Preferably, the first particle size may be 10 nm-5 μm, the second particle size may be 8.5 μm-15 μm, and the third particle size may be 18 μm-35 μm.

Preferably, the iron-based magnetic powder may have 80%-98.5% of unit weight and the adhesive may have 1.5%-20% of unit weight.

Preferably, the iron-based magnetic powder may include carbonyl (CIP), iron silicon chromium (Fe—Si—Cr), iron silicon aluminum (Fe—Si—Al), iron silicon (Fe—Si), amorphous, nanocrystalline alloy, iron nickel (FeNi), MPP iron nickel molybdenum (FeNiMo—C), silicon (Si), iron cobalt nickel (Fe—Co—Ni), manganese zinc (MnZn), nickel zinc (NiZn) or a combination thereof.

Preferably, particle size of the carbonyl may be 3 μm-8 μm, particle size of the iron silicon chromium may be 3 μm-35 μm, particle size of the nanocrystalline alloy may be 19 μm-23 μm, particle size of the amorphous may be 13 μm-28 μm, particle size of the iron nickel may be 12 μm-16 μm, particle size of the MPP iron nickel molybdenum may be 11 μm-18 μm.

Preferably, the iron-based magnetic powder may include a first powder and a second powder, the first powder and the second powder have same or different materials. Wherein the first powder has 5-95 weight of the iron-based magnetic powder and the second powder has 5-40 weight of the iron-based magnetic powder.

Preferably, the iron-based magnetic powder may include a first powder, a second powder and a third powder, the first powder, the second powder and the third powder have same or different materials. Wherein the first powder has 5-40 weight of the iron-based magnetic powder, the second powder has 5-40 weight of the iron-based magnetic powder and the third powder has 20-90 weight of the iron-based magnetic powder.

Preferably, the metal conductor may be made by gold, silver, copper, nickel or aluminum.

Preferably, the metal conductor may include a round coil or a flat coil, the metal conductor may be U shape, circle shape, ellipse shape, spiral shape, rectangular shape or I shape.

Preferably, the manufacturing method may further include the steps of: providing the first magnetic core body with a base and a columnar protrusion disposed on the base and providing the second magnetic core body with a rectangular structure having a groove facing the columnar protrusion and two channels extended from the groove; placing the metal conductor on the first magnetic core body, a hollow part of the metal conductor is inserted in the columnar protrusion and the two ends of the metal conductor being exposed outside the first magnetic core body; bending the two ends of the metal conductor and placing the two ends of the metal conductor on a surface of the first magnetic core body; placing the first magnetic core body and the metal conductor into a mold and placing the second magnetic core body on the first magnetic core body for the heating and pressing molding process.

Preferably, the manufacturing method may further include the steps of: providing the first magnetic core body with a base and a columnar protrusion disposed on the base and providing the second magnetic core body with a rectangular structure having a groove facing the columnar protrusion and two channels extended from the groove; placing the second magnetic core body into a mold; placing the metal conductor on the second magnetic core body, the metal conductor being disposed in the groove and the two ends of the metal conductor being disposed in the two channels; placing the first magnetic core body on the second magnetic core body and the metal conductor for the heating and pressing molding process.

Preferably, the manufacturing method may further include the steps of: providing the first magnetic core body with a plate structure and providing the second magnetic core body with a rectangular structure having a groove and a columnar protrusion disposed in the groove; placing the second magnetic core body into a mold; placing the metal conductor in the groove of the second magnetic core body, the two ends of the metal conductor being extended outside the second magnetic core body; bending the two ends of the metal conductor toward the second magnetic core body and the two ends of the metal conductor being perpendicular to the metal conductor; placing the first magnetic core body on the second magnetic core body and bending the two ends of the metal conductor to place the two ends of the metal conductor on outside surface of the plate structure for the heating and pressing molding process.

Preferably, the manufacturing method may further include the steps of: providing the first magnetic core body with a plate structure and providing the second magnetic core body with a rectangular structure having a groove and a columnar protrusion disposed in the groove; assembling the metal conductor with the first magnetic core body, the metal conductor being disposed on one side of the plate structure and the two ends of the metal conductor being bended and disposed on another side of the plate structure; placing the second magnetic core body into a mold; placing the metal conductor and the first magnetic core body in the groove of the second magnetic core body for the heating and pressing molding process.

Preferably, heating temperature of the heating and pressing molding process may be 180° C.-300° C., forming pressure of the heating and pressing molding process may be 5-13 T/cm³ and full pressure time of the forming pressure may be 50 s-120 s.

Preferably, an insulation layer may be formed by spray painting to cover outside surface of the first magnetic core body and the second magnetic core body, the two ends of the metal conductor are exposed outside the insulation layer after a laser stripping process and an electroplating treatment.

As mentioned previously, the power inductor device and the manufacturing method thereof may have one or more advantages as follows.
1. The power inductor device and the manufacturing method thereof may improve the uniformity of the magnetic powder filling, increase the weight of the magnetic powder, reduce the air gap, increase the density and single weight of the final product, so as to effectively increase the inductance value.
2. The power inductor device and the manufacturing method thereof may use the pre-pressing process and the heating and pressing molding process to increase the density of the power inductor device. The forming pressure can reduce about, so as to significantly reduce mold loss, increase the service life and reduce the mold cost.
3. The power inductor device and the manufacturing method thereof may reduce the material cost and the production cost. The production yield has been greatly improved, and the product can be mass-produced by automatic apparatus.

### BRIEF DESCRIPTION OF THE DRAWINGS

The technical features, detail structures, advantages and effects of the present disclosure will be described in more details hereinafter with reference to the accompanying drawings that show various embodiments of the invention as follows.

FIG. 1 and FIG. 2 are schematic diagrams of the power inductor device and manufacturing method of the power inductor device in accordance with the first embodiment of the present disclosure.

FIG. 3 is schematic diagram of the power inductor device and manufacturing method of the power inductor device in accordance with the second embodiment of the present disclosure.

FIG. 4 and FIG. 5 are schematic diagrams of the power inductor device and manufacturing method of the power inductor device in accordance with the third embodiment of the present disclosure.

### DETAILED DESCRIPTION OF THE PREFERRED EMBODIMENTS

In order to facilitate the understanding of the technical features, the contents and the advantages of the present disclosure, and the effectiveness thereof that can be achieved, the present disclosure will be illustrated in detail below through embodiments with reference to the accompanying drawings. The diagrams used herein are merely intended to be schematic and auxiliary to the specification, but are not necessary to be true scale and precise to the configuration after implementing the present disclosure. Thus, it should not be interpreted in accordance with the scale and the configuration of the accompanying drawings to limit the scope of the present disclosure on the practical implementation.

As those skilled in the art would realize, the described embodiments may be modified in various different ways. The exemplary embodiments of the present disclosure are for explanation and understanding only. The drawings and description are to be regarded as illustrative in nature and not restrictive. Similar reference numerals designate similar elements throughout the specification.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

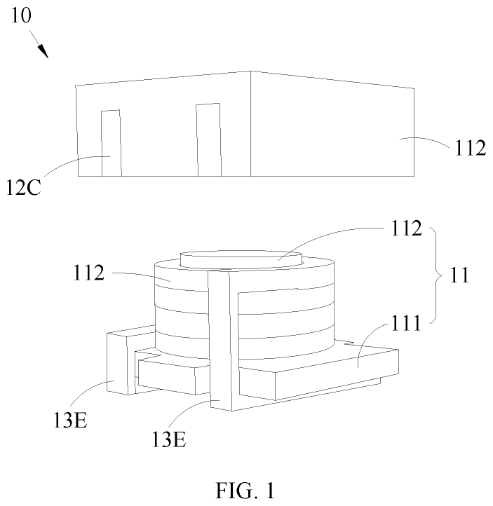

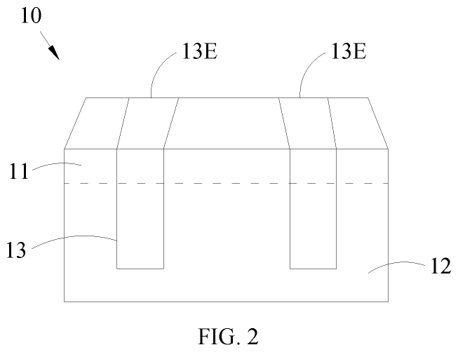

Please refer to FIG. 1 and FIG. 2, which are the schematic diagrams of the power inductor device and manufacturing method of the power inductor device in accordance with the first embodiment of the present disclosure.

As shown in FIG. 1 and FIG. 2, the power inductor device 10 includes a first magnetic core body 11, a second magnetic core body 12 and a metal conductor 13. The first magnetic core body 11, the metal conductor 13 and the second magnetic body 12 are closely combined as an integrated power inductor structure. The first magnetic core body 11 includes a base 111 and a columnar protrusion 112 disposed on the base 111. The second magnetic core body 12 is a rectangular structure. The rectangular structure has a groove facing the columnar protrusion 112 and two channels 12C are extended from the groove. The two channels 12C may be extended from the groove in the same direction. In the present embodiment, the columnar protrusion 112 is a cylindrical structure. However, the present disclosure is not limited to circle shape. In other embodiment, the columnar protrusion 112 may be ellipse, rectangle, polygon, or other special shapes corresponding to the shape of the metal conductor 13.

When the second magnetic core body 12 disposes on the first magnetic core body 11, an accommodating space is formed between the first magnetic core body 11 and the second magnetic core body 12. That is, the space between the groove and the columnar protrusion 112 form the accommodating space and the space between the two channels 12C and the base 111 form openings at side surface of the first magnetic core body 11. The metal conductor 13 is disposed in the accommodating space, and two ends 13E of the metal conductor 13 pass through the openings and are exposed outside the first magnetic core body 11.

The first magnetic core body 11 is formed by a first magnetic powder and the second magnetic core body 12 is formed by a second magnetic powder. The first magnetic powder and the second magnetic powder include an iron-based magnetic powder mixed with an adhesive. The iron-based magnetic powder has a first particle size, a second particle size and a third particle size, the first particle size is smaller than the second particle size and the second particle size is smaller than the third particle size. In the present embodiment, the first particle size may be 10 nm-5 μm, the second particle size may be 8.5 μm-15 μm, and the third particle size may be 18 μm-35 μm. The adhesive may be an organic resin, an epoxy resin or an aldehyde resin. In the present embodiment, the iron-based magnetic powder may have 80%-98.5% of unit weight and the adhesive may have 1.5%-20% of unit weight.

The iron-based magnetic powder may include carbonyl (CIP), iron silicon chromium (Fe—Si—Cr), iron silicon aluminum (Fe—Si—Al), iron silicon (Fe—Si), amorphous, nanocrystalline alloy, iron nickel (FeNi), MPP iron nickel molybdenum (FeNiMo—C), silicon (Si), iron cobalt nickel (Fe—Co—Ni), manganese zinc (MnZn), nickel zinc (NiZn) or a combination thereof. The particle size of the carbonyl may be 3 μm-8 μm, the particle size of the iron silicon chromium may be 3 μm-35 μm, the particle size of the nanocrystalline alloy may be 19 μm-23 μm, the particle size of the amorphous may be 13 μm-28 μm, the particle size of the iron nickel may be 12 μm-16 μm, the particle size of the MPP iron nickel molybdenum may be 11 μm-18 μm. As mentioned to the different particle sizes above, the carbonyl may choose 3, 5 or 7 μm particle, the iron silicon chromium may choose 11, 15, 18, 22, 25 or 30 μm particle, the nanocrystalline alloy may choose 19, 21 or 23 μm particle, the amorphous may choose 15, 18 or 22 μm particle, the iron nickel may choose 13 or 15 μm particle, the MPP iron nickel molybdenum may choose 13, 15 or 17 μm particle. The different sizes of particle can be used to meet the large, the medium and the small size range of the particles. By using the mixture of different particle sizes, the uniformity of the magnetic powder filling can be improved, the weight of the magnetic powder can be effectively increased, the air gap can be reduced, the density and single weight of the final product can be increased 3.5-8%, so as to effectively increase the inductance value about 2-6%.

The first magnetic powder and the second magnetic powder may choose same or different iron-based magnetic powders for forming the magnetic core body. The iron-based magnetic powder may include more than one material. For example, the iron-based magnetic powder may include a first powder and a second powder, the first powder and the second powder have same or different materials selected from the above iron-based magnetic powders. The first powder has 5-95 weight of the iron-based magnetic powder and the second powder has 5-40 weight of the iron-based magnetic powder. In other embodiment, the iron-based magnetic powder may include a first powder, a second powder and a third powder, the first powder, the second powder and the third powder have same or different materials. The first powder has 5-40 weight of the iron-based magnetic powder, the second powder has 5-40 weight of the iron-based magnetic powder and the third powder has 20-90 weight of the iron-based magnetic powder.

The metal conductor 13 can be made by gold, silver, copper, nickel or aluminum. The metal conductor 13 is a flat coil with round winding in circle shape. The coil number is determined by the product specs. In other embodiment, the metal conductor 13 may be a round coil, and the metal conductor may be U shape, ellipse shape, spiral shape, rectangular shape or I shape. The metal conductor 13 has a hollow part corresponding to the columnar protrusion 112. The metal conductor 13 has two ends 13E, one is extended from the upper part of the coil and the other one is extended from the bottom part of the coil. The metal conductor 13 is disposed on the base 111 and the two ends 13E of the metal conductor 13 are extended to another side of the base 111. The detail manufacturing method of forming the power inductor device 10 will be described as follows.

Please refer to FIG. 1, the manufacturing method provides the first magnetic core body 11, the first magnetic core body 11 is formed by the first magnetic powder. The first magnetic powder includes the at least one iron-based magnetic powder mixed with the adhesive, and the at least one iron-based magnetic powder has large particle size, medium particle size and small particle size powders. The mixture of the iron-based magnetic powder and the adhesive are pre-pressed to form the base 111 and the columnar protrusion 112. Similarly, the manufacturing method provides the second magnetic core body 12, the second magnetic core body 11 is formed by the second magnetic powder. The second magnetic powder includes the at least one iron-based magnetic powder mixed with the adhesive, and the at least one iron-based magnetic powder has large particle size, medium particle size and small particle size powders. The mixture of the iron-based magnetic powder and the adhesive are pre-pressed to form the rectangular structure having a groove and two channels 13E extended from the groove. In the pre-press process, the first magnetic core body 11 and the second magnetic core body 12 can be cured by heat. However, the present disclosure is not limited to this. In other embodiment, the first magnetic core body 11 and the second magnetic core body 12 are provided without curing process.

After forming the first magnetic core body 11 and the second magnetic core body 12, the manufacturing method provides metal conductor 13. The metal conductor 13 is made by the flat coil with the hollow part in the middle. The two ends 13E are extended from the upper part and the bottom part of the coil. The metal conductor 13 is placed on the first magnetic core body 11, the hollow part of the metal conductor 13 is inserted in the columnar protrusion 112 and the two ends 13E of the metal conductor 13 are exposed outside the first magnetic core body 11. The two ends 13E of the metal conductor 13 are bended twice so the two ends 13E are facing the direction opposite to the extension direction. That is, the two ends 13E of the metal conductor 13 are placed on the other side surface of the first magnetic core body 11.

Since the first magnetic core body 11 and metal conductor 13 are assemble, the assembly parts are placed into a mold. Afterward, the second magnetic core body 12 is placed on the first magnetic core body 11 for the heating and pressing molding process. When the first magnetic core body 11, the second magnetic core body 12 and the metal conductor 13 are put in the mold, the metal conductor 13 is disposed in an accommodating space between the first magnetic core body 11 and the second magnetic core body 12 and two ends 13E of the metal conductor 13 are exposed outside the first magnetic core body 11. The heating and pressing molding process is conducted to the mold. The heating temperature of the heating and pressing molding process may be 180° C.-300° C., the forming pressure of the heating and pressing molding process may be 5-13 T/cm³ and the full pressure time of the forming pressure may be 50 s-120 s. After heating and pressing molding process, the power inductor device 10 with the integrated power inductor structure is obtained as shown in FIG. 2. Since the magnetic core body is formed by the pre-pressing process and the heating and pressing molding process is used, the magnetic powder is closely combined to increase the density of the device. In addition, the forming pressure can reduce about 30%, so as to significantly reduce mold loss, increase the service life and reduce the mold cost. The device body will not break or crack when releasing from the mold. The production yield has been greatly improved, and the product can be mass-produced by automatic apparatus.

The first magnetic core body 11, the metal conductor 13 and the second magnetic body 12 are closely combined to obtain an integrated power inductor structure. The power inductor device 10 may further include an insulation layer, the insulation layer covers outside surface of the first magnetic core body 11 and the second magnetic core body 12. The insulation layer may be formed by spray painting. After the spray painting process, the laser stripping process and the electroplating treatment are conducted to remove the paint and to expose the two ends 13E of the metal conductor 13. The two ends 13E may further conduct the electroplating process to form the electro pads or pins.

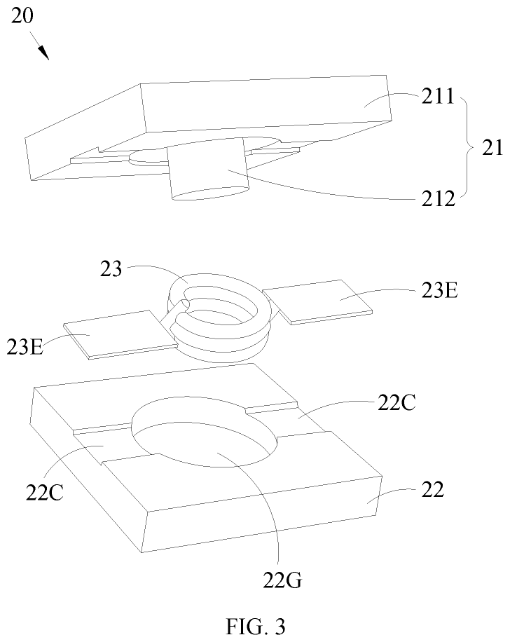

Please refer to FIG. 3, which is the schematic diagram of the power inductor device and manufacturing method of the power inductor device in accordance with the second embodiment of the present disclosure.

As shown in FIG. 3, the power inductor device 20 includes a first magnetic core body 21, a second magnetic core body 22 and a metal conductor 23. The first magnetic core body 21, the metal conductor 23 and the second magnetic body 22 are closely combined as an integrated power inductor structure. The first magnetic core body 21 includes a base 211 and a columnar protrusion 212 disposed on the base 211. The second magnetic core body 22 is a rectangular structure. The rectangular structure has a groove 22G facing the columnar protrusion 212 and two channels 22C are extended from the groove 22G. The two channels 22C may be extended from the groove in the opposite direction. In the present embodiment, the columnar protrusion 212 is a cylindrical structure. However, the present disclosure is not limited to circle shape. In other embodiment, the columnar protrusion 212 may be ellipse, rectangle, polygon, or other special shapes corresponding to the shape of the metal conductor 23.

When the second magnetic core body 22 disposes on the first magnetic core body 21, an accommodating space is formed between the first magnetic core body 21 and the second magnetic core body 22. That is, the space between the groove 22G and the columnar protrusion 212 form the accommodating space and the space between the two channels 22C and the base 211 form openings at side surface of the first magnetic core body 21 and the second magnetic core body 22. The metal conductor 23 is disposed in the accommodating space, and two ends 13E of the metal conductor 23 pass through the openings and are exposed outside the first magnetic core body 21.

The first magnetic core body 21 is formed by a first magnetic powder and the second magnetic core body 22 is formed by a second magnetic powder. The first magnetic powder and the second magnetic powder include an iron-based magnetic powder mixed with an adhesive. The iron-based magnetic powder has a first particle size, a second particle size and a third particle size, the first particle size is smaller than the second particle size and the second particle size is smaller than the third particle size. In the present embodiment, the first particle size may be 10 nm-5 μm, the second particle size may be 8.5 μm-15 μm, and the third particle size may be 18 μm-35 μm. The adhesive may be an organic resin, an epoxy resin or an aldehyde resin. In the present embodiment, the iron-based magnetic powder may have 80%-98.5% of unit weight and the adhesive may have 1.5%-20% of unit weight.

The iron-based magnetic powder may include carbonyl (CIP), iron silicon chromium (Fe—Si—Cr), iron silicon aluminum (Fe—Si—Al), iron silicon (Fe—Si), amorphous, nanocrystalline alloy, iron nickel (FeNi), MPP iron nickel molybdenum (FeNiMo—C), silicon (Si), iron cobalt nickel (Fe—Co—Ni), manganese zinc (MnZn), nickel zinc (NiZn) or a combination thereof. The particle size of the carbonyl may be 3 μm-8 μm, the particle size of the iron silicon chromium may be 3 μm-35 μm, the particle size of the nanocrystalline alloy may be 19 μm-23 μm, the particle size of the amorphous may be 13 μm-28 μm, the particle size of the iron nickel may be 12 μm-16 μm, the particle size of the MPP iron nickel molybdenum may be 11 μm-18 μm. As mentioned to the different particle sizes above, the carbonyl may choose 3, 5 or 7 μm particle, the iron silicon chromium may choose 11, 15, 18, 22, 25 or 30 μm particle, the nanocrystalline alloy may choose 19, 21 or 23 μm particle, the amorphous may choose 15, 18 or 22 μm particle, the iron nickel may choose 13 or 15 μm particle, the MPP iron nickel molybdenum may choose 13, 15 or 17 μm particle. The different sizes of particle can be used to meet the large, the medium and the small size range of the particles. By using the mixture of different particle sizes, the uniformity of the magnetic powder filling can be improved, the weight of the magnetic powder can be effectively increased, the air gap can be reduced, the density and single weight of the final product can be increased 3.5-8%, so as to effectively increase the inductance value about 2-6%.

The first magnetic powder and the second magnetic powder may choose same or different iron-based magnetic powders for forming the magnetic core body. The iron-based magnetic powder may include more than one material. For example, the iron-based magnetic powder may include a first powder and a second powder, the first powder and the second powder have same or different materials selected from the above iron-based magnetic powders. The first powder has 5-95 weight of the iron-based magnetic powder and the second powder has 5-40 weight of the iron-based magnetic powder. In other embodiment, the iron-based magnetic powder may include a first powder, a second powder and a third powder, the first powder, the second powder and the third powder have same or different materials. The first powder has 5-40 weight of the iron-based magnetic powder, the second powder has 5-40 weight of the iron-based magnetic powder and the third powder has 20-90 weight of the iron-based magnetic powder.

The metal conductor 23 can be made by gold, silver, copper, nickel or aluminum. The metal conductor 23 is a round coil with round winding in circle shape. The coil number is determined by the product specs. In other embodiment, the metal conductor 23 may be a flat coil, and the metal conductor may be U shape, ellipse shape, spiral shape, rectangular shape or I shape. The metal conductor 23 has a hollow part corresponding to the columnar protrusion 212 and the groove 22G. The metal conductor 23 has two ends 23E, one is extended from the upper part of the coil and the other one is extended from the bottom part of the coil. The metal conductor 23 is disposed on the groove 22G and the two ends 23E of the metal conductor 23 are extended through the two channels 22C. The detail manufacturing method of forming the power inductor device 20 will be described as follows.

Please refer to FIG. 3, the manufacturing method provides the first magnetic core body 21 and the second magnetic core body 22. The first magnetic core body 21 is formed by the first magnetic powder. The first magnetic powder includes the at least one iron-based magnetic powder mixed with the adhesive, and the at least one iron-based magnetic powder has large particle size, medium particle size and small particle size powders. Similarly, the second magnetic core body 22 is formed by the second magnetic powder. The second magnetic powder includes the at least one iron-based magnetic powder mixed with the adhesive, and the at least one iron-based magnetic powder has large particle size, medium particle size and small particle size powders. In the previous embodiment, the first magnetic powder and the second magnetic powder are pre-pressed to form the structure of two core bodies. However, the first magnetic core body 21 and the second magnetic core body 22 can be provided without the pre-pressing process. That is, the first magnetic powder and the second magnetic powder can be directly put into the mold for the heating and pressing molding process.

In the present embodiment, the second magnetic core body 22 is provided by the second magnetic powder and the second magnetic core body 22 is placed into the mold. The manufacturing method provides metal conductor 23. The metal conductor 23 is made by the round coil with the hollow part in the middle. The two ends 23E are extended from the upper part and the bottom part of the coil. The metal conductor 23 is put into the mold and is placed on the second magnetic core body 22, the metal conductor 23 is disposed in the groove 22G and the two ends 23E of the metal conductor are disposed in the two channels 22C. Afterward, the first magnetic core body 21 is put into the mold. The columnar protrusion 212 of the first magnetic core body 21 is inserted in the hollow part of the metal conductor 23 and the base 211 covers the second magnetic core body 22 and the metal conductor 23. The two ends 23E of the metal conductor 23 are extended in opposite direction and are exposed from two side surfaces of the first magnetic core body 21 and the second magnetic core body 22.

When the first magnetic core body 21, the second magnetic core body 22 and the metal conductor 23 are put in the mold, the metal conductor 23 is disposed in an accommodating space between the first magnetic core body 21 and the second magnetic core body 22 and two ends 23E of the metal conductor 23 are exposed outside the first magnetic core body 21 and the second magnetic core body 22. The heating and pressing molding process is conducted to the mold. The heating temperature of the heating and pressing molding process may be 180° C.-300° C., the forming pressure of the heating and pressing molding process may be 5-13 T/cm³ and the full pressure time of the forming pressure may be 50 s-120 s. After heating and pressing molding process, the power inductor device 20 with the integrated power inductor structure is obtained. Since the magnetic core body is formed by the heating and pressing molding process is used, the magnetic powder is closely combined to increase the density of the device. In addition, the forming pressure can reduce about 30%, so as to significantly reduce mold loss, increase the service life and reduce the mold cost. The device body will not break or crack when releasing from the mold. The production yield has been greatly improved, and the product can be mass-produced by automatic apparatus.

The first magnetic core body 21, the metal conductor 23 and the second magnetic body 22 are closely combined to obtain an integrated power inductor structure. The power inductor device 20 may further include an insulation layer, the insulation layer covers outside surface of the first magnetic core body 21 and the second magnetic core body 22. The insulation layer may be formed by spray painting. After the spray painting process, the laser stripping process and the electroplating treatment are conducted to remove the paint and to expose the two ends 23E of the metal conductor 23. The two ends 23E may further conduct the electroplating process to form the electro pads or pins.

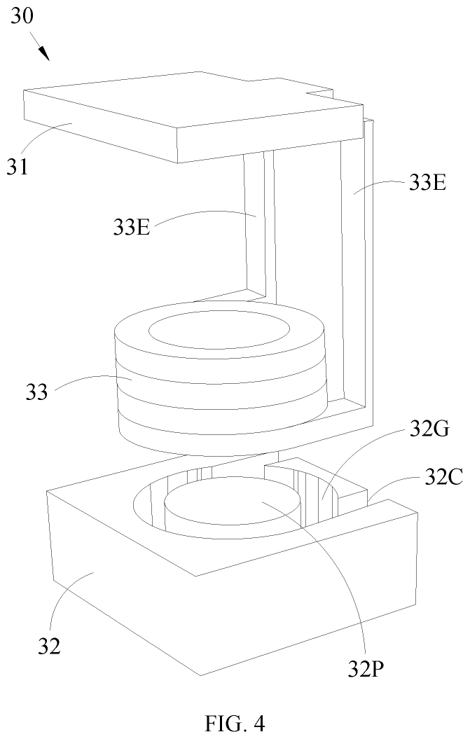

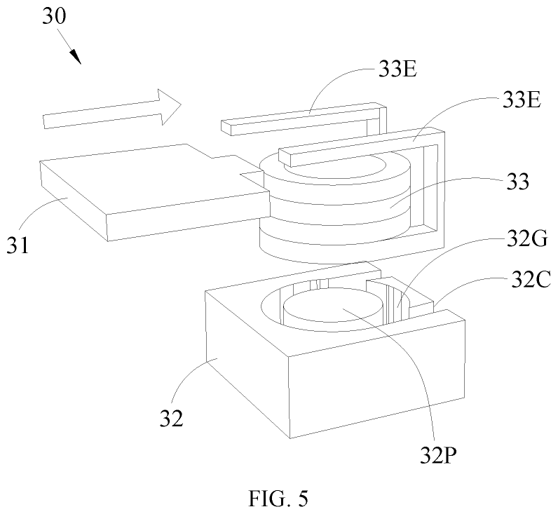

Please refer to FIG. 4 and FIG. 5, which are schematic diagrams of the power inductor device and manufacturing method of the power inductor device in accordance with the third embodiment of the present disclosure.

As shown in FIG. 4 and FIG. 5, the power inductor device 30 includes a first magnetic core body 31, a second magnetic core body 32 and a metal conductor 33. The first magnetic core body 31, the metal conductor 33 and the second magnetic body 32 are closely combined as an integrated power inductor structure. The first magnetic core body 31 includes a plate structure. The second magnetic core body 32 is a rectangular structure having a groove 32G and a columnar protrusion 32P disposed in the groove 32G. The columnar protrusion 32P faces the plate structure and two channels 32C extended from the groove 32G. The two channels 32C may be extended from the groove in the same direction. In the present embodiment, the columnar protrusion 32P is a cylindrical structure. However, the present disclosure is not limited to circle shape. In other embodiment, the columnar protrusion 32P may be ellipse, rectangle, polygon, or other special shapes corresponding to the shape of the groove 32G or the metal conductor 33.

When the second magnetic core body 32 disposes on the first magnetic core body 31, an accommodating space is formed between the first magnetic core body 31 and the second magnetic core body 32. That is, the space between the groove 32G and the plate structure form the accommodating space and the two channels 32C form openings at side surface of the second magnetic core body 32. The metal conductor 33 is disposed in the accommodating space, and two ends 33E of the metal conductor 33 pass through the openings and are exposed outside the first magnetic core body 31.

The first magnetic core body 31 is formed by a first magnetic powder and the second magnetic core body 32 is formed by a second magnetic powder. The first magnetic powder and the second magnetic powder include an iron-based magnetic powder mixed with an adhesive. The iron-based magnetic powder has a first particle size, a second particle size and a third particle size, the first particle size is smaller than the second particle size and the second particle size is smaller than the third particle size. In the present embodiment, the first particle size may be 10 nm-5 μm, the second particle size may be 8.5 μm-15 μm, and the third particle size may be 18 μm-35 μm. The adhesive may be an organic resin, an epoxy resin or an AIP. 160X aldehyde resin. In the present embodiment, the iron-based magnetic powder may have 80%-98.5% of unit weight and the adhesive may have 1.5%-20% of unit weight.

The iron-based magnetic powder may include carbonyl (CIP), iron silicon chromium (Fe—Si—Cr), iron silicon aluminum (Fe—Si—Al), iron silicon (Fe—Si), amorphous, nanocrystalline alloy, iron nickel (FeNi), MPP iron nickel molybdenum (FeNiMo—C), silicon (Si), iron cobalt nickel (Fe—Co—Ni), manganese zinc (MnZn), nickel zinc (NiZn) or a combination thereof. The particle size of the carbonyl may be 3 μm-8 μm, the particle size of the iron silicon chromium may be 3 μm-35 μm, the particle size of the nanocrystalline alloy may be 19 μm-23 μm, the particle size of the amorphous may be 13 μm-28 μm, the particle size of the iron nickel may be 12 μm-16 μm, the particle size of the MPP iron nickel molybdenum may be 11 μm-18 μm. As mentioned to the different particle sizes above, the carbonyl may choose 3, 5 or 7 μm particle, the iron silicon chromium may choose 11, 15, 18, 22, 25 or 30 μm particle, the nanocrystalline alloy may choose 19, 21 or 23 μm particle, the amorphous may choose 15, 18 or 22 μm particle, the iron nickel may choose 13 or 15 μm particle, the MPP iron nickel molybdenum may choose 13, 15 or 17 μm particle. The different sizes of particle can be used to meet the large, the medium and the small size range of the particles. By using the mixture of different particle sizes, the uniformity of the magnetic powder filling can be improved, the weight of the magnetic powder can be effectively increased, the air gap can be reduced, the density and single weight of the final product can be increased 3.5-8%, so as to effectively increase the inductance value about 2-6%.

The first magnetic powder and the second magnetic powder may choose same or different iron-based magnetic powders for forming the magnetic core body. The iron-based magnetic powder may include more than one material. For example, the iron-based magnetic powder may include a first powder and a second powder, the first powder and the second powder have same or different materials selected from the above iron-based magnetic powders. The first powder has 5-95 weight of the iron-based magnetic powder and the second powder has 5-40 weight of the iron-based magnetic powder. In other embodiment, the iron-based magnetic powder may include a first powder, a second powder and a third powder, the first powder, the second powder and the third powder have same or different materials. The first powder has 5-40 weight of the iron-based magnetic powder, the second powder has 5-40 weight of the iron-based magnetic powder and the third powder has 20-90 weight of the iron-based magnetic powder.

The metal conductor 33 can be made by gold, silver, copper, nickel or aluminum. The metal conductor 33 is a flat coil with round winding in circle shape. The coil number is determined by the product specs. In other embodiment, the metal conductor 33 may be a round coil, and the metal conductor may be U shape, ellipse shape, spiral shape, rectangular shape or I shape. The metal conductor 33 has a hollow part corresponding to the columnar protrusion 32P. The metal conductor 33 has two ends 33E, one is extended from the upper part of the coil and the other one is extended from the bottom part of the coil. The metal conductor 33 is disposed on the groove 32G and the two ends 33E of the metal conductor 33 are extended through the two channels 32C. The manufacturing method of forming the power inductor device 30 may have different process described as follows.

Please refer to FIG. 4, the manufacturing method provides the first magnetic core body 31 and the second magnetic core body 32. The first magnetic core body 31 is formed by the first magnetic powder. The first magnetic powder includes the at least one iron-based magnetic powder mixed with the adhesive, and the at least one iron-based magnetic powder has large particle size, medium particle size and small particle size powders. Similarly, the second magnetic core body 32 is formed by the second magnetic powder. The second magnetic powder includes the at least one iron-based magnetic powder mixed with the adhesive, and the at least one iron-based magnetic powder has large particle size, medium particle size and small particle size powders. The first magnetic core body 31 and the second magnetic core body 32 can be provided with or without the pre-pressing process.

In the present embodiment, the second magnetic core body 32 is provided by the second magnetic powder and the second magnetic core body 32 is placed into the mold. The manufacturing method provides metal conductor 33. The metal conductor 33 is made by the flat coil with the hollow part in the middle. The two ends 33E are extended from the upper part and the bottom part of the coil. The metal conductor 33 is put into the mold and is placed on the second magnetic core body 32, the metal conductor 33 is disposed in the groove 32G and the hollow part of the metal conductor 33 is corresponded to the columnar protrusion 32P. The two ends 33E of the metal conductor 33 are disposed in the two channels 32C. Afterward, bending the two ends 33E of the metal conductor 33 toward the second magnetic core body 32 and the two ends 33E of the metal conductor 33 are perpendicular to the metal conductor 33. In the present embodiment, the two ends are bended and facing the upward direction.

The first magnetic core body 31 is put into the mold. The plate structure covers the second magnetic core body 32. The two ends 33E of the metal conductor 33 are extended through the side surface. The manufacturing process bends the two ends 33E again so that the two ends 33E of the metal conductor 33 are placed on outside surface of the plate structure.

When the first magnetic core body 31, the second magnetic core body 32 and the metal conductor 33 are assembled and put in the mold, the metal conductor 33 is disposed in an accommodating space between the first magnetic core body 31 and the second magnetic core body 32 and two ends 33E of the metal conductor 33 are exposed outside the first magnetic core body 31 and the second magnetic core body 32. The heating and pressing molding process is conducted to the mold. The heating temperature of the heating and pressing molding process may be 180° C.-300° C., the forming pressure of the heating and pressing molding process may be 5-13 T/cm³ and the full pressure time of the forming pressure may be 50 s-120 s. After heating and pressing molding process, the power inductor device 30 with the integrated power inductor structure is obtained. Since the magnetic core body is formed by the heating and pressing molding process is used, the magnetic powder is closely combined to increase the density of the device. In addition, the forming pressure can reduce about 30%, so as to significantly reduce mold loss, increase the service life and reduce the mold cost. The device body will not break or crack when releasing from the mold. The production yield has been greatly improved, and the product can be mass-produced by automatic apparatus.

The first magnetic core body 31, the metal conductor 33 and the second magnetic body 32 are closely combined to obtain an integrated power inductor structure. The power inductor device 30 may further include an insulation layer, the insulation layer covers outside surface of the first magnetic core body 31 and the second magnetic core body 32. The insulation layer may be formed by spray painting. After the spray painting process, the laser stripping process and the electroplating treatment are conducted to remove the paint and to expose the two ends 33E of the metal conductor 33. The two ends 33E may further conduct the electroplating process to form the electro pads or pins.

In other embodiment, please refer to FIG. 5, the manufacturing method provides the first magnetic core body 31 and the second magnetic core body 32. The first magnetic core body 31 is formed by the first magnetic powder. The first magnetic powder includes the at least one iron-based magnetic powder mixed with the adhesive, and the at least one iron-based magnetic powder has large particle size, medium particle size and small particle size powders. Similarly, the second magnetic core body 32 is formed by the second magnetic powder. The second magnetic powder includes the at least one iron-based magnetic powder mixed with the adhesive, and the at least one iron-based magnetic powder has large particle size, medium particle size and small particle size powders. The first magnetic core body 31 and the second magnetic core body 32 can be provided with or without the pre-pressing process.

In the present embodiment, the first magnetic core body 31 and the metal conductor 33 are assembled first. The metal conductor 33 is disposed on one side of the plate structure and the two ends 33E are bended twice to place on another side of the plate structure. The second magnetic core body 32 is provided by the second magnetic powder and the second magnetic core body 32 is placed into the mold. The first magnetic core body 31 and the metal conductor 33 are together put into the mold, the metal conductor 33 is disposed in the groove 32G and the hollow part of the metal conductor 33 is corresponded to the columnar protrusion 32P. The part of the two ends 33E are disposed in the two channels 32C.

When the first magnetic core body 31, the second magnetic core body 32 and the metal conductor 33 are assembled and put in the mold, the metal conductor 33 is disposed in an accommodating space between the first magnetic core body 31 and the second magnetic core body 32 and two ends 33E of the metal conductor 33 are exposed outside the first magnetic core body 31 and the second magnetic core body 32. The heating and pressing molding process is conducted to the mold. The heating temperature of the heating and pressing molding process may be 180° C.-300° C., the forming pressure of the heating and pressing molding process may be 5-13 T/cm³ and the full pressure time of the forming pressure may be 50 s-120 s. After heating and pressing molding process, the power inductor device 30 with the integrated power inductor structure is obtained. Since the magnetic core body is formed by the heating and pressing molding process is used, the magnetic powder is closely combined to increase the density of the device. In addition, the forming pressure can reduce about 30%, so as to significantly reduce mold loss, increase the service life and reduce the mold cost. The device body will not break or crack when releasing from the mold. The production yield has been greatly improved, and the product can be mass-produced by automatic apparatus.

The first magnetic core body 31, the metal conductor 33 and the second magnetic body 32 are closely combined to obtain an integrated power inductor structure. The power inductor device 30 may further include an insulation layer, the insulation layer covers outside surface of the first magnetic core body 31 and the second magnetic core body 32. The insulation layer may be formed by spray painting. After the spray painting process, the laser stripping process and the electroplating treatment are conducted to remove the paint and to expose the two ends 33E of the metal conductor 33. The two ends 33E may further conduct the electroplating process to form the electro pads or pins.

The above embodiments provide several examples to the power inductor device. However, the present disclosure is not limited to this. In other embodiments, the shape or the numbers of the magnetic core body and the metal conductor can be different. The design can be decided by the requirements of the electronic components.

The present disclosure disclosed herein has been described by means of specific embodiments. However, numerous modifications, variations and enhancements can be made thereto without departing from the spirit and scope of the disclosure set forth in the claims.

What is claimed is:

1. A power inductor device comprising:
a first magnetic core body formed by a first magnetic powder;
a second magnetic core body formed by a second magnetic powder, the second magnetic core body disposing on the first magnetic core body to form an accommodating space between the first magnetic core body and the second magnetic core body; and
a metal conductor disposed in the accommodating space, and two ends of the metal conductor being exposed outside the first magnetic core body, the first magnetic core body, the metal conductor and the second magnetic body being closely combined by a heating and pressing molding process to obtain an integrated power inductor structure;
wherein the first magnetic powder and the second magnetic powder comprise an iron-based magnetic powder mixed with an adhesive, the iron-based magnetic powder having a first particle size, a second particle size and a third particle size, the first particle size is smaller than the second particle size and the second particle size is smaller than the third particle size.

2. The power inductor device of claim 1, wherein the first particle size is 10 nm-5 μm, the second particle size is 8.5 μm-15 μm, and the third particle size is 18 μm-35 μm.

3. The power inductor device of claim 1, wherein the iron-based magnetic powder has 80%-98.5% of unit weight and the adhesive has 1.5%-20% of unit weight.

4. The power inductor device of claim 1, wherein the iron-based magnetic powder comprises carbonyl, iron silicon chromium, iron silicon aluminum, iron silicon, amorphous, nanocrystalline alloy, iron nickel, MPP iron nickel molybdenum, silicon, iron cobalt nickel, manganese zinc, nickel zinc or a combination thereof.

5. The power inductor device of claim 4, wherein particle size of the carbonyl is 3 μm-8 μm, particle size of the iron silicon chromium is 3 μm-35 μm, particle size of the nanocrystalline alloy is 19 μm-23 μm, particle size of the amorphous is 13 μm-28 μm, particle size of the iron nickel is 12 μm-16 μm, particle size of the MPP iron nickel molybdenum is 11 μm-18 μm.

6. The power inductor device of claim 4, wherein the iron-based magnetic powder comprises a first powder and a second powder, the first powder and the second powder have same or different materials;
wherein the first powder has 5-95 weight of the iron-based magnetic powder and the second powder has 5-40 weight of the iron-based magnetic powder.

7. The power inductor device of claim 4, wherein the iron-based magnetic powder comprises a first powder, a second powder and a third powder, the first powder, the second powder and the third powder have same or different materials;
wherein the first powder has 5-40 weight of the iron-based magnetic powder, the second powder has 5-40 weight of the iron-based magnetic powder and the third powder has 20-90 weight of the iron-based magnetic powder.

8. The power inductor device of claim 1, wherein the metal conductor is made by gold, silver, copper, nickel or aluminum.

9. The power inductor device of claim 1, wherein the metal conductor comprises a round coil or a flat coil, the metal conductor is U shape, circle shape, ellipse shape, spiral shape, rectangular shape or I shape.

10. The power inductor device of claim 1, wherein the first magnetic core body comprises a base and a columnar protrusion disposed on the base, the second magnetic core body comprises a rectangular structure having a groove facing the columnar protrusion and two channels extended from the groove;
wherein the groove and the columnar protrusion form the accommodating space and the two channels and the base form openings at side surface of the first magnetic core body, the metal conductor is disposed in the accommodating space and the two ends of the metal conductor pass through the openings.

11. The power inductor device of claim 10, wherein the two channels are extended from the groove in same direction or in opposite direction.

12. The power inductor device of claim 1, wherein the first magnetic core body comprises a plate structure, the second magnetic core body comprises a rectangular structure having a groove and a columnar protrusion disposed in the groove, the columnar protrusion faces the plate structure and two channels extended from the groove;
wherein the groove and the columnar protrusion form the accommodating space and the two channels form openings at side surface of the second magnetic core body, the metal conductor is disposed in the accommodating space and the two ends of the metal conductor pass through the openings.

13. The power inductor device of claim 12, wherein the two channels are extended from the groove in same direction or in opposite direction.

14. The power inductor device of claim 1, wherein heating temperature of the heating and pressing molding process is 180° C.-300° C., forming pressure of the heating and pressing molding process is 5-13 T/cm³ and full pressure time of the forming pressure is 50 s-120 s.

15. The power inductor device of claim 1, further comprising an insulation layer, the insulation layer covering outside surface of the first magnetic core body and the second magnetic core body, and the two ends of the metal conductor being exposed outside the insulation layer.

16. A manufacturing method of a power inductor device, the manufacturing method comprising following steps of:
providing a first magnetic core body, a second magnetic core body and a metal conductor, the first magnetic core body being formed by a first magnetic powder and the second magnetic core body being formed by a second magnetic powder;
assembling the first magnetic core body, the second magnetic core body and the metal conductor, the metal conductor being placing in an accommodating space between the first magnetic core body and the second magnetic core body and two ends of the metal conductor being exposed outside the first magnetic core body;
conducting a heating and pressing molding process to the first magnetic core body, the second magnetic core body and the metal conductor to form an integrated power inductor structure;
wherein the first magnetic powder and the second magnetic powder comprise an iron-based magnetic powder mixed with an adhesive, the iron-based magnetic powder having a first particle size, a second particle size and a third particle size, the first particle size is smaller than the second particle size and the second particle size is smaller than the third particle size.

17. The manufacturing method of claim 16, wherein the first particle size is 10 nm-5 μm, the second particle size is 8.5 μm-15 μm, and the third particle size is 18 μm-35 μm.

18. The manufacturing method of claim 17, wherein the iron-based magnetic powder has 80%-98.5% of unit weight and the adhesive has 1.5%-20% of unit weight.

19. The manufacturing method of claim 16, wherein the iron-based magnetic powder comprises carbonyl, iron silicon chromium, iron silicon aluminum, iron silicon, amorphous, nanocrystalline alloy, iron nickel, MPP iron nickel molybdenum, silicon, iron cobalt nickel, manganese zinc, nickel zinc or a combination thereof.

20. The manufacturing method of claim 19, wherein particle size of the carbonyl is 3 μm-8 μm, particle size of the iron silicon chromium is 3 μm-35 μm, particle size of the nanocrystalline alloy is 19 μm-23 μm, particle size of the amorphous is 13 μm-28 μm, particle size of the iron nickel is 12 μm-16 μm, particle size of the MPP iron nickel molybdenum is 11 μm-18 μm.

21. The manufacturing method of claim 19, wherein the iron-based magnetic powder comprises a first powder and a second powder, the first powder and the second powder have same or different materials;
wherein the first powder has 5-95 weight of the iron-based magnetic powder and the second powder has 5-40 weight of the iron-based magnetic powder.

22. The manufacturing method of claim 19, wherein the iron-based magnetic powder comprises a first powder, a second powder and a third powder, the first powder, the second powder and the third powder have same or different materials;
wherein the first powder has 5-40 weight of the iron-based magnetic powder, the second powder has 5-40 weight of the iron-based magnetic powder and the third powder has 20-90 weight of the iron-based magnetic powder.

23. The manufacturing method of claim 16, wherein the metal conductor is made by gold, silver, copper, nickel or aluminum.

24. The manufacturing method of claim 16, wherein the metal conductor comprises a round coil or a flat coil, the metal conductor is U shape, circle shape, ellipse shape, spiral shape, rectangular shape or I shape.

25. The manufacturing method of claim 16, further comprises the steps of:
providing the first magnetic core body with a base and a columnar protrusion disposed on the base and providing the second magnetic core body with a rectangular structure having a groove facing the columnar protrusion and two channels extended from the groove;
placing the metal conductor on the first magnetic core body, a hollow part of the metal conductor is inserted in the columnar protrusion and the two ends of the metal conductor being exposed outside the first magnetic core body;
bending the two ends of the metal conductor and placing the two ends of the metal conductor on a surface of the first magnetic core body;
placing the first magnetic core body and the metal conductor into a mold and placing the second magnetic core body on the first magnetic core body for the heating and pressing molding process.

26. The manufacturing method of claim 16, further comprises the steps of:
providing the first magnetic core body with a base and a columnar protrusion disposed on the base and providing the second magnetic core body with a rectangular structure having a groove facing the columnar protrusion and two channels extended from the groove;
placing the second magnetic core body into a mold;
placing the metal conductor on the second magnetic core body, the metal conductor being disposed in the groove and the two ends of the metal conductor being disposed in the two channels;
placing the first magnetic core body on the second magnetic core body and the metal conductor for the heating and pressing molding process.

27. The manufacturing method of claim 16, further comprises the steps of:
providing the first magnetic core body with a plate structure and providing the second magnetic core body with a rectangular structure having a groove and a columnar protrusion disposed in the groove;
placing the second magnetic core body into a mold;
placing the metal conductor in the groove of the second magnetic core body, the two ends of the metal conductor being extended outside the second magnetic core body;
bending the two ends of the metal conductor toward the second magnetic core body and the two ends of the metal conductor being perpendicular to the metal conductor;
placing the first magnetic core body on the second magnetic core body and bending the two ends of the metal conductor to place the two ends of the metal conductor on outside surface of the plate structure for the heating and pressing molding process.

28. The manufacturing method of claim 16, further comprises the steps of:
providing the first magnetic core body with a plate structure and providing the second magnetic core body with a rectangular structure having a groove and a columnar protrusion disposed in the groove;
assembling the metal conductor with the first magnetic core body, the metal conductor being disposed on one side of the plate structure and the two ends of the metal conductor being bended and disposed on another side of the plate structure;
placing the second magnetic core body into a mold;
placing the metal conductor and the first magnetic core body in the groove of the second magnetic core body for the heating and pressing molding process.

29. The manufacturing method of claim 16, wherein heating temperature of the heating and pressing molding process is 180° C.-300° C., forming pressure of the heating and pressing molding process is 5-13 T/cm³ and full pressure time of the forming pressure is 50 s-120 s.

30. The manufacturing method of claim 16, wherein an insulation layer is formed by spray painting to cover outside surface of the first magnetic core body and the second magnetic core body, the two ends of the metal conductor being exposed outside the insulation layer after a laser stripping process and an electroplating treatment.
